(19) United States
(12) Patent Application Publication
(10) Pub. No.: US 2017/0253064 A1
(43) Pub. Date: Sep. 7, 2017

(54) Printing Method for Indicating Lifetime of Product

(71) Applicant: Simple Green Co., Ltd., Huatan Township (TW)

(72) Inventors: Chen-I Kao, Huatan Township (TW); Glenn Malcolm Boghosian, Beverly Hills, CA (US); Chen-Ju Lai, Taipei City (TW); Shang-Chieh Kao, Huatan Township (TW); Shu-Chen Huang, Huatan Township (TW); Yu-Jen Pan, Changhua City (TW); Yong-Han Shin, Hemei Township (TW)

(21) Appl. No.: 15/398,862

(22) Filed: Jan. 5, 2017

(30) Foreign Application Priority Data
Mar. 1, 2016 (TW) 105106047

(51) Int. Cl. B41M 5/382

(52) U.S. Cl. CPC B41M 5/38235

(57) ABSTRACT

A printing method includes preparing a dye receiving zone. Then, sublimation transfer paper is stuck to the dye receiving zone. Then, ink on the sublimation transfer paper is released in a heat pressing manner and permeates the dye receiving zone so that the interior of the dye receiving zone forms multiple blocks of color warning areas. Then, the sublimation transfer paper is removed from the dye receiving zone. Then, the dye receiving zone is cleaned. Finally, the dye receiving zone is worked and molded to have a determined profile. Thus, when the dye receiving zone ages and becomes thin due to a successive loss during a use procedure, the color warning areas in the dye receiving zone are exposed gradually, so that the user judges if the dye receiving zone needs to be replaced according to the loss extent of the dye receiving zone.

### BACKGROUND OF THE INVENTION

1. Field of the Invention

The present invention relates to a printing method and, more particularly, to a printing method for indicating the lifetime of a product.

2. Description of the Related Art

A transfer printing method comprises preparing a medium film with various figures, and transferring the medium film to the surface of an object by a determined pressure. The most popular transfer printing method is heat transfer. A conventional heat transfer method is used to print and transfer patterns of an ink layer onto a heatproof substrate. The heat transfer technology is available for various products, such as electric appliances, common commodities, decorative items or the like. The products made by the heat transfer technology is resistant to erosion, impact, aging, wear and fading and is fireproof, thereby enhancing the versatility of the heat transfer technology. In practice, the patterns or figures are directly transferred to the surface of a product by the heat transfer technology to enhance the appearance of the product and to satisfy the consumer's requirement. However, the user cannot judge the whole wear condition of the product during a long-term utilization.

### BRIEF SUMMARY OF THE INVENTION

The primary objective of the present invention is to provide a printing method for identifying the wear condition of a product so as to indicate the lifetime of the product.

In accordance with the present invention, there is provided a printing method comprising a first step a) of preparing a dye receiving zone; a second step b) of sticking sublimation transfer paper; a third step c) of heat pressing transfer; a fourth step d) of cleaning; and a fifth step e) of working and molding. The first step a) includes a first substep a1) of selecting a primary staple including a plurality of material molecules, a plurality of ink affinitive molecules and a plurality of ink repulsive molecules; a second substep a2) of placing the material molecules, the ink affinitive molecules and the ink repulsive molecules into a stirring machine and applying a high speed stirring operation to achieve an evenly mixing effect; a third substep a3) of adding a determined amount of chemical agent during the high speed stirring operation, wherein the chemical agent attracts the material molecules and the ink affinitive molecules and repels the ink repulsive molecules, so that the material molecules and the ink affinitive molecules are bonded together, and the ink repulsive molecules are forced into gaps produced by the material molecules when the material molecules are stirred and squeezed, thereby forming a blank; and a fourth substep a4) of working and molding the blank by a molding machine to obtain a dye receiving zone. The second step b) includes sticking a sheet of sublimation transfer paper on the dye receiving zone. The third step c) includes releasing ink from the sublimation transfer paper in a heat pressing manner, wherein when the dye receiving zone is heated, its molecule structure is expanded and produces many clearances, so that the ink permeates the dye receiving zone and is adhered to the material molecules and the ink affinitive molecules, while the ink repulsive molecules contained in the material molecules stop the ink and prevent the ink from permeating the material molecules completely, such that an interior of the dye receiving zone forms multiple blocks of color warning areas, wherein when the dye receiving zone ages and becomes thin due to a successive loss during a use procedure, the color warning areas contained in the dye receiving zone are exposed gradually according to a loss extent of the dye receiving zone, so as to notify a user so that the user judges if the dye receiving zone needs to be replaced according to the loss extent of the dye receiving zone. The fourth step d) includes tearing the sublimation transfer paper and cleaning the dye receiving zone. The fifth step e) includes working and molding the dye receiving zone so that the dye receiving zone has a determined profile.

In the third step c), each of the material molecules has a dyeing capacity that can receive permeation of the ink of the sublimation transfer paper and is ranged between 20% and 60%, each of the ink affinitive molecules has a dyeing capacity that can receive permeation of the ink of the sublimation transfer paper and is ranged between 80% and 100%, and each of the ink repulsive molecules has a dyeing capacity that can receive permeation of the ink of the sublimation transfer paper and is ranged between 0% and 10%.

Each of the color warning areas of the dye receiving zone has a dye intensity that is determined by a proportion of the ink affinitive molecules and the ink repulsive molecules.

Preferably, each of the color warning areas of the dye receiving zone has a single color or has different colors to enhance an identification effect.

Preferably, each of the ink affinitive molecules is made of polar ink affinitive material that is selected from an artificial fiber or an artificial petrifaction staple.

Alternatively, each of the ink affinitive molecules is made of polar ink affinitive material that is selected from a natural mineral powder or a natural staple.

Alternatively, each of the ink affinitive molecules is made of polar ink affinitive material that is selected from rubber, plastics or composite material that is added with a chemical agent.

Preferably, each of the ink repulsive molecules is made of nonpolar ink affinitive material that is selected from rubber, plastics or composite material that is added with a chemical agent.

In the third step c), the ink is released from the sublimation transfer paper at a heat pressing temperature ranged between 100° C. and 300° C.

In the third step e), the dye receiving zone presents an integral shape of a mat, a tire, a shoe sole, an oil seal, a rehabilitating tool, a sensitive member, a passive member, an electrical consumption member, a cellphone fitting or a hot consumption member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a printing method in accordance with the preferred embodiment of the present invention.

FIG. 2 is a flow chart showing the complete substeps of a first step of the printing method in accordance with the preferred embodiment of the present invention.

### DETAILED DESCRIPTION OF THE INVENTION

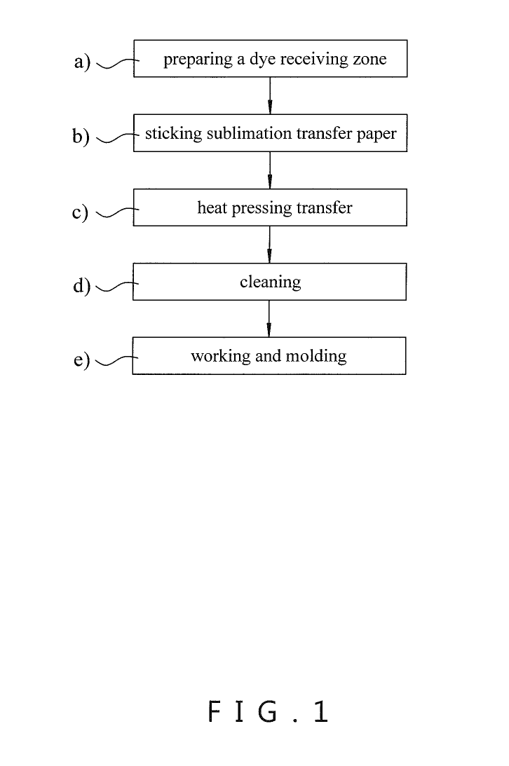

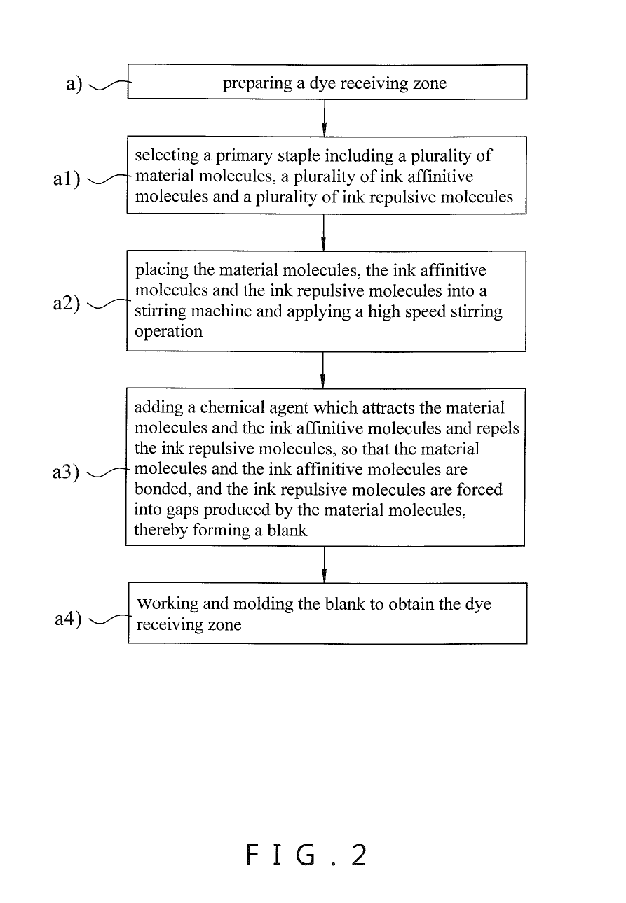

Referring to FIGS. 1 and 2, a printing method in accordance with the preferred embodiment of the present invention comprises a first step a) of preparing a dye receiving zone; a second step b) of sticking sublimation transfer paper; a third step c) of heat pressing transfer; a fourth step d) of cleaning; and a fifth step e) of working and molding.

The first step a) includes a first substep a1) of selecting a primary staple including a plurality of material molecules, a plurality of ink affinitive molecules and a plurality of ink repulsive molecules; a second substep a2) of placing the material molecules, the ink affinitive molecules and the ink repulsive molecules into a stirring machine and applying a high speed stirring operation to achieve an evenly mixing effect; a third substep a3) of adding a determined amount of chemical agent during the high speed stirring operation, wherein the chemical agent attracts the material molecules and the ink affinitive molecules and repels the ink repulsive molecules, so that the material molecules and the ink affinitive molecules are bonded together, and the ink repulsive molecules are forced into gaps produced by the material molecules when the material molecules are stirred and squeezed, thereby forming a blank; and a fourth substep a4) of working and molding the blank by a molding machine to obtain a dye receiving zone.

The second step b) includes sticking a sheet of sublimation transfer paper on the dye receiving zone.

The third step c) includes releasing ink from the sublimation transfer paper in a heat pressing manner, wherein when the dye receiving zone is heated, its molecule structure is expanded and produces many clearances, so that the ink permeates the dye receiving zone and is adhered to the material molecules and the ink affinitive molecules, while the ink repulsive molecules contained in the material molecules stop the ink and prevent the ink from permeating the material molecules completely, such that an interior of the dye receiving zone forms multiple blocks of color warning areas, wherein when the dye receiving zone ages and becomes thin due to a successive loss during a use procedure, the color warning areas contained in the dye receiving zone are exposed gradually according to a loss extent of the dye receiving zone, so as to notify a user so that the user judges if the dye receiving zone needs to be replaced according to the loss extent of the dye receiving zone.

The fourth step d) includes tearing the sublimation transfer paper and cleaning the dye receiving zone.

The fifth step e) includes working and molding the dye receiving zone so that the dye receiving zone has a determined profile.

In the third step c), the successive loss of the dye receiving zone includes wear loss, wetting loss, oxidation loss, breakage loss, aging loss, fatigue loss, fading loss, hot loss and electrical loss.

With regard to the wear loss, the dye receiving zone rubs a hard particle or object (such as a solid metal) during the use procedure so that the surface of the dye receiving zone is worn and becomes thin, and the color warning areas contained in the dye receiving zone are exposed gradually.

With regard to the wetting loss, water in the air is attached to the surface of the dye receiving zone or permeates voids of the surface of the dye receiving zone into the dye receiving zone during usage and storage of the dye receiving zone, so that the surface of the dye receiving zone is wet and worn, and the color warning areas contained in the dye receiving zone are exposed gradually.

With regard to the oxidation loss, oxygen produces a radical chain reaction on the material molecules, the ink affinitive molecules and the ink repulsive molecules during usage and storage of the dye receiving zone, so that the chains of all of the molecules of the dye receiving zone are broken or interconnected excessively, and the features of the dye receiving zone are changed. Thus, the surface of the dye receiving zone is worn and becomes thin due to the oxidation phenomenon so that the color warning areas contained in the dye receiving zone are exposed gradually.

With regard to the breakage loss, when the sun light is irradiated on the dye receiving zone during usage and storage of the dye receiving zone, the chains of all of the molecules of the dye receiving zone are broken or interconnected excessively, and all of the molecules of the dye receiving zone absorb the solar energy and produce radicals, thereby causing and accelerating an oxidation chain reaction. Thus, the surface of the dye receiving zone is broken and becomes thin due to irradiation of the sun light so that the color warning areas contained in the dye receiving zone are exposed gradually.

With regard to the aging loss, when the dye receiving zone is subjected to environmental conditions (including oxygen, water, light, microbes and chemical media) during usage and storage of the dye receiving zone, the chemical composition and structure of all of the molecules of the dye receiving zone are changed, and the physical features are worsened (such as become hardening, sticking, discoloring or brittle), so that the dye receiving zone will age, and the color warning areas contained in the dye receiving zone are exposed gradually.

With regard to the fatigue loss, the surface of the dye receiving zone is worn and becomes thin due to fatigue during usage of the dye receiving zone so that the color warning areas contained in the dye receiving zone are exposed gradually.

With regard to the fading loss, the dye receiving zone fades due to the sunlight during usage and storage of the dye receiving zone, so that the loss of the dye receiving zone is determined by the fading extent of the dye receiving zone.

With regard to the hot loss, when the dye receiving zone rubs a heat conducting object, the dye receiving zone is affected by the heat energy, so that the surface of the dye receiving zone is worn and becomes thin due to a hot loss during usage and storage of the dye receiving zone, and the color warning areas contained in the dye receiving zone are exposed gradually.

With regard to the electrical loss, the dye receiving zone is affected by a radio wave (or an electromagnetic field) transmitted by a wireless transmitter, an RFID or an electric voltage device, so that the surface of the dye receiving zone is worn and becomes thin due to an electrical loss during usage and storage of the dye receiving zone, and the color warning areas contained in the dye receiving zone are exposed gradually.

In the third step c), each of the material molecules has a dyeing capacity that can receive permeation of the ink of the sublimation transfer paper and is ranged between 20% and 60%, each of the ink affinitive molecules has a dyeing capacity that can receive permeation of the ink of the sublimation transfer paper and is ranged between 80% and 100%, and each of the ink repulsive molecules has a dyeing capacity that can receive permeation of the ink of the sublimation transfer paper and is ranged between 0% and 10%.

When the dye attached to the ink repulsive molecules presents a pseudo adhesive state, the dye will detach from the ink repulsive molecules due to hit of an external force.

Each of the color warning areas of the dye receiving zone has a dye intensity that is determined by a proportion of the ink affinitive molecules and the ink repulsive molecules. Preferably, each of the color warning areas of the dye receiving zone has a single color or has different colors to enhance an identification effect.

Preferably, each of the ink affinitive molecules is made of polar ink affinitive material that is selected from an artificial fiber or an artificial petrifaction staple.

In the preferred embodiment of the present invention, the artificial fiber includes rayon or polymeric fiber. The polymeric fiber is formed by a petrifaction staple and includes cellulose diacetate, cellulose triacetate, PE, PP, PAN, PVC, PET, PBT, nylon and PU. The artificial fiber is woven to present a state of a thread, yarn, cotton or nonwoven cloth.

Alternatively, each of the ink affinitive molecules is made of polar ink affinitive material that is selected from a natural mineral powder or a natural staple. In the preferred embodiment of the present invention, the natural mineral powder includes silicon.

Alternatively, each of the ink affinitive molecules is made of polar ink affinitive material that is selected from rubber, plastics or composite material that is added with a chemical agent.

In the preferred embodiment of the present invention, the chemical agent includes a transfer powder, PP treating agent, PP adhesive agent, EVA treating agent, hardener, defoamer, flat agent, dispersant, gold powder, silver paste, fluorescent powder, temporarily coagulating paste, flatting paste, wash version solvent, slow drying solvent, very slow drying solvent, special ink and dedicated solvent.

Preferably, each of the ink repulsive molecules is made of nonpolar ink affinitive material that is selected from rubber, plastics or composite material that is added with a chemical agent. The chemical agent includes a solvent that is incompatible with the ink.

In the third step c), the ink is released from the sublimation transfer paper at a heat pressing temperature ranged between 100° C. and 300° C.

In the preferred embodiment of the present invention, the heat pressing transfer is performed by a conventional hot press which applies determined high temperature and pressure during a determined period of time, so that the ink is released from the sublimation transfer paper. The ink of the sublimation transfer paper includes colors, figures, patterns or trademarks.

In addition, when the ink affinitive molecules of different materials are processed by the heat pressing transfer, the temperature, pressure and time applied by the hot press on the dye receiving zone have different values that are listed as follows:

| name | temperature | | pressure | time | |
|---|---|---|---|---|---|
| polyester fabrics | 205-220° | C. | 0.5 kg/cm | 10-30 | second |
| low elastic polyester | 195-205° | C. | 0.5 kg/cm | 30 | second |
| fabric deformation | | | | | |
| triacetate fabrics | 190-200° | C. | 0.5 kg/cm | 30-40 | second |
| nylon fabrics | 195-205° | C. | 0.5 kg/cm | 30-40 | second |
| acrylic fabrics | 200-210° | C. | 0.5 kg/cm | 30 | second |
| diacetate fabrics | 185° | C. | 0.5 kg/cm | 15-20 | second |
| Polyacrylonitrile | 190-220° | C. | 0.5 kg/cm | 10-15 | second |

From the above table, it is clear that, when the ink affinitive molecules of different materials are processed by the heat pressing transfer, the heat pressing temperature is ranged between 100° C. and 300° C.

In the third step e), the dye receiving zone presents an integral shape of a mat, a tire, a shoe sole, an oil seal, a rehabilitating tool, a sensitive member, a passive member, an electrical consumption member, a cellphone fitting or a hot consumption member.

When the dye receiving zone has the shape of a mat, the dye receiving zone is available for yoga and the like. Thus, after the dye receiving zone with the shape of a mat is worn successively and becomes thin during a long-term utilization, the color warning areas contained in the dye receiving zone are exposed gradually, so as to notify the user, so that the user judges if the mat needs to be replaced according to the loss extent of the dye receiving zone.

When the dye receiving zone has the shape of a tire, the dye receiving zone is available for a car and the like. Thus, after the dye receiving zone with the shape of a tire is worn successively and becomes thin during a long-term utilization, the color warning areas contained in the dye receiving zone are exposed gradually, so as to notify the user, so that the user judges if the tire needs to be replaced according to the loss extent of the dye receiving zone.

When the dye receiving zone has the shape of a shoe sole, the dye receiving zone is available for shoes and the like. Thus, after the dye receiving zone with the shape of a shoe sole is worn successively and becomes thin during a long-term utilization, the color warning areas contained in the dye receiving zone are exposed gradually, so as to notify the user, so that the user judges if the shoe sole needs to be replaced according to the loss extent of the dye receiving zone.

When the dye receiving zone has the shape of an oil seal, the dye receiving zone is available for a mechanical mechanism and the like. Thus, after the dye receiving zone with the shape of an oil seal is worn successively and becomes thin during a long-term utilization, the color warning areas contained in the dye receiving zone are exposed gradually, so as to notify the user, so that the user judges if the oil seal needs to be replaced according to the loss extent of the dye receiving zone.

When the dye receiving zone has the shape of an electrical consumption member, the dye receiving zone is available for a wireless transmitter, an RFID, an electric voltage device and the like. Thus, after the dye receiving zone with the shape of an electrical consumption member is worn successively and becomes thin during a long-term utilization, the color warning areas contained in the dye receiving zone are exposed gradually, so as to notify the user, so that the user judges if the electrical consumption member needs to be replaced according to the loss extent of the dye receiving zone.

When the dye receiving zone has the shape of a cellphone fitting, the dye receiving zone is available for a cellphone shell, a cellphone frame, a cellphone ear plug and the like. Thus, after the dye receiving zone with the shape of a cellphone fitting is worn successively and becomes thin during a long-term utilization, the color warning areas contained in the dye receiving zone are exposed gradually, so as to notify the user, so that the user judges if the cellphone fitting needs to be replaced according to the loss extent of the dye receiving zone.

In conclusion, the printing method of the present invention is described as follows. First of all, a dye receiving zone is prepared. Then, a sheet of transfer paper is stuck to the sublimation transfer paper. Then, ink on the sublimation transfer paper is released in a heat pressing manner and permeates the interior of the dye receiving zone so that the interior of the dye receiving zone forms multiple blocks of color warning areas. Then, the sublimation transfer paper is torn and removed from the dye receiving zone. Then, the dye receiving zone is cleaned to accomplish the transfer. Finally, the dye receiving zone is worked and molded to have a determined profile.

The dye receiving zone is selected from a primary staple including a plurality of material molecules, a plurality of ink affinitive molecules and a plurality of ink repulsive molecules. The material molecules, the ink affinitive molecules and the ink repulsive molecules are placed into a stirring machine to perform a high speed stirring operation to achieve an evenly mixing effect. A determined amount of chemical agent is added during the high speed stirring operation. The chemical agent attracts the material molecules and the ink affinitive molecules and repels the ink repulsive molecules, so that the material molecules and the ink affinitive molecules are bonded together, and the ink repulsive molecules are forced into gaps produced by the material molecules when the material molecules are stirred and squeezed, thereby forming a blank. The blank is worked and molded by a molding machine to obtain the dye receiving zone. A sheet of transfer paper is stuck on the dye receiving zone. The ink is released from the sublimation transfer paper in a heat pressing manner. When the dye receiving zone is heated, its molecule structure is expanded and produces many clearances, so that the ink permeates the dye receiving zone and is adhered to the material molecules and the ink affinitive molecules, while the ink repulsive molecules contained in the material molecules stop the ink and prevent the ink from permeating the material molecules completely, such that the interior of the dye receiving zone forms multiple blocks of color warning areas. When the dye receiving zone ages and becomes thin due to a successive loss during a use procedure, the color warning areas contained in the dye receiving zone are exposed gradually according to the loss extent of the dye receiving zone, so as to notify a user so that the user judges if the dye receiving zone needs to be replaced according to the whole loss extent of the dye receiving zone.

Accordingly, the printing method of the present invention is used for identifying the whole wear loss of various products so as to indicate the lifetime of the products.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A printing method comprising:
a first step a) of preparing a dye receiving zone;
a second step b) of sticking sublimation transfer paper;
a third step c) of heat pressing transfer;
a fourth step d) of cleaning; and
a fifth step e) of working and molding;
wherein:
the first step a) includes:
a first substep a1) of selecting a primary staple including a plurality of material molecules, a plurality of ink affinitive molecules and a plurality of ink repulsive molecules;
a second substep a2) of placing the material molecules, the ink affinitive molecules and the ink repulsive molecules into a stirring machine and applying a high speed stirring operation to achieve an evenly mixing effect;
a third substep a3) of adding a determined amount of chemical agent during the high speed stirring operation, wherein the chemical agent attracts the material molecules and the ink affinitive molecules and repels the ink repulsive molecules, so that the material molecules and the ink affinitive molecules are bonded together, and the ink repulsive molecules are forced into gaps produced by the material molecules when the material molecules are stirred and squeezed, thereby forming a blank; and
a fourth substep a4) of working and molding the blank by a molding machine to obtain a dye receiving zone;
the second step b) includes sticking a sheet of sublimation transfer paper on the dye receiving zone;
the third step c) includes releasing ink from the sublimation transfer paper in a heat pressing manner, wherein when the dye receiving zone is heated, its molecule structure is expanded and produces many clearances, so that the ink permeates the dye receiving zone and is adhered to the material molecules and the ink affinitive molecules, while the ink repulsive molecules contained in the material molecules stop the ink and prevent the ink from permeating the material molecules completely, such that an interior of the dye receiving zone forms multiple blocks of color warning areas, wherein when the dye receiving zone ages and becomes thin due to a successive loss during a use procedure, the color warning areas contained in the dye receiving zone are exposed gradually according to a loss extent of the dye receiving zone, so as to notify a user so that the user judges if the dye receiving zone needs to be replaced according to the loss extent of the dye receiving zone;
the fourth step d) includes tearing the sublimation transfer paper and cleaning the dye receiving zone; and
the fifth step e) includes working and molding the dye receiving zone so that the dye receiving zone has a determined profile.

2. The printing method of claim 1, wherein in the third step c), each of the material molecules has a dyeing capacity that can receive permeation of the ink of the sublimation transfer paper and is ranged between 20% and 60%, each of the ink affinitive molecules has a dyeing capacity that can receive permeation of the ink of the sublimation transfer paper and is ranged between 80% and 100%, and each of the ink repulsive molecules has a dyeing capacity that can receive permeation of the ink of the sublimation transfer paper and is ranged between 0% and 10%.

3. The printing method of claim 2, wherein each of the color warning areas of the dye receiving zone has a dye intensity that is determined by a proportion of the ink affinitive molecules and the ink repulsive molecules.

4. The printing method of claim 3, wherein each of the color warning areas of the dye receiving zone has a single color or has different colors to enhance an identification effect.

5. The printing method of claim 2, wherein each of the ink affinitive molecules is made of polar ink affinitive material that is selected from an artificial fiber or an artificial petrifaction staple.

6. The printing method of claim 2, wherein each of the ink affinitive molecules is made of polar ink affinitive material that is selected from a natural mineral powder or a natural staple.

7. The printing method of claim 2, wherein each of the ink affinitive molecules is made of polar ink affinitive material that is selected from rubber, plastics or composite material that is added with a chemical agent.

8. The printing method of claim 2, wherein each of the ink repulsive molecules is made of nonpolar ink affinitive material that is selected from rubber, plastics or composite material that is added with a chemical agent.

9. The printing method of claim 1, wherein in the third step c), the ink is released from the sublimation transfer paper at a heat pressing temperature ranged between 100° C. and 300° C.

10. The printing method of claim 1, wherein in the third step e), the dye receiving zone presents an integral shape of a mat, a tire, a shoe sole, an oil seal, a rehabilitating tool, a sensitive member, a passive member, an electrical consumption member, a cellphone fitting or a hot consumption member.
